(19) United States
(12) Patent Application Publication
(10) Pub. No.: US 2024/0249259 A1
(43) Pub. Date: Jul. 25, 2024

(54) TOUCH PHONE TRANSACTIONS

(71) Applicant: Capital One Services, LLC, McLean, VA (US)

(72) Inventor: Benjamin Rappoport, Chevy Chase, MD (US)

(73) Assignee: Capital One Services, LLC, McLean, VA (US)

(21) Appl. No.: 18/100,809

(22) Filed: Jan. 24, 2023

(51) Int. Cl. G06Q 20/10; G06Q 20/22; G06Q 20/32; G06Q 20/34; G06Q 20/38; G06Q 20/40

(52) U.S. Cl. CPC G06Q 20/105; G06Q 20/223; G06Q 20/3278; G06Q 20/352; G06Q 20/382; G06Q 20/4014; G06Q 20/4018

(57) ABSTRACT

A method, a system, and a computer program product for executing transactions using contactless cards. A near-field communication (NFC) exchange is executed between a first device and a second device upon the first device being detected by the second device to be located within a predetermined distance of the second device. The first device is associated with an electronic deposit account capable of receiving an electronic transfer of funds. At least one identification data associated with the first device is received from the first device based on the NFC exchange and sent to a server. A response from the server is processed and includes an authentication data corresponding to the first device and associated with the sent identification data. A request for electronically transferring predetermined electronic funds to the electronic deposit account is received. Electronically transfer of the predetermined electronic funds to the electronic deposit account is performed based on the processing of the authentication data.

### TECHNICAL FIELD

This disclosure relates generally to data processing and, in particular, to execution of transactions using contactless cards, and more particularly, to enabling tap-to-pay and/or tap-to-refill transactions between contactless cards and mobile phones, and/or alternatively, between mobile devices.

### BACKGROUND

Tap-to-pay transactions have become some of the most popular ways of paying for goods and services. Tap-to-pay is based on radio-frequency identification (RFID) technology that may be embedded into credit cards, smartphones, and other mobile devices. This technology allows users to make credit card transactions by bringing their cards and/or smartphones within a specific distance of (or tapping on) specific areas of point-of-sale terminals, which enables transfer of certain data for the purposes of making a payment. However, existing tap-to-pay methods lack some protection of users from fraud, may provide for numerous points of exposure to bacteria, thereby endangering health of users, and typically perform transactions at a slower speed.

### SUMMARY

In some implementations, the current subject matter relates to a computer implemented method for executing transactions using contactless cards. The method may include executing a near-field communication (NFC) exchange between a first device and a second device upon the first device being detected by the second device to be located within a predetermined distance of the second device. The first device may be associated with an electronic deposit account capable of receiving an electronic transfer of funds. The method may also include receiving at least one identification data associated with the first device, and sending at least one identification data to a server. The identification data may be received from the first device based on the NFC exchange. The method may further include processing a response from the server, where the response may include an authentication data corresponding to the first device and be associated with the sending of the identification data; receiving a request for electronically transferring predetermined electronic funds to the electronic deposit account; and electronically transferring, based on the processing of the authentication data, the predetermined electronic funds to the electronic deposit account.

In some implementations, the current subject matter may include one or more of the following optional features. The executing may include triggering execution of an application by the second device for performing the electronically transferring. The execution of the application may include generating at least one user interface, wherein the user interface may include one or more form fields configured to be automatically populated using a first device data received from the first device during the NFC exchange. In some implementations, the first device may be a contactless card and the second device may be a mobile device, where the first device data may include a contactless card data. The contactless card data may include at least one of the following: an account number associated with the contactless card, an expiration date associated with the contactless card, a card verification value (CVV) associated with the contactless card, a billing address associated with the contactless card, a name of a user associated with the contactless card, and any combination thereof.

In some implementations, the mobile device may be an active computing device and the contactless card may be a passive computing device, where, in response to the executing of the NFC exchange, the mobile device may be configured to transmit at least one message to cause the contactless card to become temporarily active and transmit at least one of: at least one identification data and the contactless card data, to the mobile device.

In some implementations, the authentication data corresponding to the contactless card may include encrypted authentication data corresponding to the contactless card. Processing of the response from the server may include decrypting the encrypted authentication data corresponding to the contactless card; upon determining, based on the decrypted authentication data, that the contactless card has been authenticated by the server, performing the electronically transferring; and upon determining, based on the decrypted authentication data, that the contactless card has not been authenticated by the server, preventing the electronically transferring.

In some implementations, the contactless card may include at least one of the following: a credit card, a debit card, an electronic gift card, a pre-paid credit card, a pre-paid debit card, and any combination thereof.

In some implementations, the electronically transferring may include transmitting the received request for electronically transferring the predetermined electronic funds to the server, where the server may communicate the received request to at least another electronic deposit account storing the predetermined electronic funds; and electronically transferring, in response to the server communicating the received request, the predetermined electronic funds from at least another electronic deposit to the electronic deposit account. At least another electronic deposit may be associated with the mobile device.

In some implementations, the first device may be a first mobile device and the second device may be a second mobile device. The execution of the NFC exchange may include a peer-to-peer communication between the first mobile device and the second mobile device. The electronic deposit account may include a first electronic deposit account associated with the first mobile device. A second electronic deposit account may be associated with the second mobile device. The electronic transfer may include electronically transferring, using the peer-to-peer communication, the predetermined electronic funds from the second electronic deposit account to the first electronic deposit account.

In some implementations, the current subject matter relates to a system for executing transactions using contactless cards. The system may include at least one processor and at least one non-transitory storage media storing instructions, that when executed by the processor, cause the at least one processor to perform operations including receiving at least one identification data associated with a first device communicatively coupled to a second device using a near-field communication (NFC), and sending the received identification data to a server. The identification data may be received from the first device based on an NFC exchange between the first device and the second device. The instructions may also include processing an authentication data, received from the server and responsive to the identification data, corresponding to the first device, receiving a request for electronically transferring predetermined electronic funds to an electronic deposit account associated with the first device, and electronically transferring, based on the processing of the authentication data, in response to the received request, the predetermined electronic funds to the electronic deposit account.

In some implementations, the current subject matter may include one or more of the following optional features. The identification data transmitted to the server may be encrypted. The first device may be a contactless card and the second device may be a mobile device, where the first device data may include a contactless card data. The contactless card data may include at least one of the following: an account number associated with the contactless card, an expiration date associated with the contactless card, a card verification value (CVV) associated with the contactless card, a billing address associated with the contactless card, a name of a user associated with the contactless card, and any combination thereof. The mobile device may be an active computing device and the contactless card may be a passive computing device. The mobile device may be configured to transmit at least one message to cause the contactless card to become temporarily active and transmit at least one of: at least one identification data and the contactless card data, to the mobile device.

In some implementations, the first device may be a first mobile device and the second device may be a second mobile device. The communicative coupling of the first and second devices may include a peer-to-peer communication between the first mobile device and the second mobile device.

In some implementations, the current subject matter relates to a computer program product for executing transactions using contactless cards. The computer program product may include a non-transitory machine-readable medium storing instructions that, when executed by at least one programmable processor, cause the at least one programmable processor to perform operations including sending, using a near-field communication (NFC) exchange, at least one communication between a first device and a second device upon the first device being detected by the second device, where the first device may be associated with an electronic deposit account capable of receiving an electronic transfer of funds, transmitting at least one identification data associated with the first device to a server, where the identification data may be received from the first device in response to at least one communication exchanged between the first device and the second device, processing, based on the transmitting, a response from the server, the response including an authentication data corresponding to the first device; and electronically transferring, based on the processing of the authentication data, predetermined electronic funds to the electronic deposit account.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for executing one or more transactions, according to some implementations of the current subject matter;

FIG. 2 illustrates an exemplary system which uses a peer-to-peer NFC exchange communication, according to some implementations of the current subject matter;

FIG. 3 illustrates an exemplary process for execution of a transaction, according to some implementations of the current subject matter;

FIG. 4 illustrates another exemplary process for execution of a transaction, according to some implementations of the current subject matter;

FIG. 5 illustrates yet another exemplary process for execution of a transaction, according to some implementations of the current subject matter;

FIG. 6 illustrates a data transmission system, according to some implementations of the current subject matter;

FIG. 7 illustrates a data transmission system, according to some implementations of the current subject matter;

FIG. 8 illustrates an exemplary contactless card, according to some implementations of the current subject matter;

FIG. 9 illustrates an exemplary transaction card component, according to some implementations of the current subject matter;

FIG. 10 illustrates an exemplary sequence flow, according to some implementations of the current subject matter;

FIG. 11 illustrates an exemplary data structure, according to some implementations of the current subject matter;

FIG. 12 is a diagram of an exemplary key system, according to some implementations of the current subject matter;

FIG. 13 is a flowchart of an exemplary method for generating a cryptogram, according to some implementations of the current subject matter;

FIG. 14 illustrates an aspect of the subject matter, according to some implementations of the current subject matter; and

FIG. 15 illustrates an aspect of the subject matter; according to some implementations of the current subject matter.

### DETAILED DESCRIPTION

To address these and potentially other deficiencies of currently available solutions, one or more implementations of the current subject matter relate to methods, systems, articles of manufacture, and the like that can, among other possible advantages, provide execution of transactions using contactless cards, and enable tap-to-pay and/or tap-to-refill transactions between contactless cards and mobile phones, and/or alternatively, between mobile devices.

In some implementations, the current subject matter generally relates to enabling tap-to-pay and/or tap-to-refill transactions using a contactless card and a mobile phone, and/or one mobile device and another mobile device. The current subject matter may be configured to implement near-field communications to enable execution of one or more transactions. For example, in the contactless card-mobile phone scenario, a user may bring a contactless card within a particular area surrounding the mobile device (e.g., mobile device's geofence) to pay for a particular item, service, etc. Alternatively, or in addition to, the user may use a system to “refill” a prepaid card, a gift card, etc. using funds that may be transferred from an account that is separate from an account that may be associated with the contactless card. The current subject matter may be configured to perform similar operations in the mobile-to-mobile device transactions. Some of the advantages of the current subject matter may include fraud prevention (e.g., by executing authentication of the contactless card performed using a communicatively coupled server) as well as time savings associated with payment, refilling of contactless cards.

In some implementations, the current subject matter may be configured to execute a near field communication (NFC) exchange between a contactless card (or another mobile device) and a mobile device, upon the mobile device detecting that the contactless card is located within a predetermined distance from the mobile device. The mobile device may be configured to act as an “active” component and provide power to energize the contactless card, which may be considered as a “passive” component. The mobile device may be securely linked to an account at a financial institution that may have available funds deposited therein (e.g., a checking account, a saving account, etc.). The linking of the mobile device and the deposit account may be configured to allow the mobile device to request transfer of funds from the deposit account to any desired destination (e.g., another account, a prepaid card, a gift card, etc.). Access to the account from the mobile device may be secured/protected using various authentication/authorization mechanisms (e.g., username and password, user biometrics, passcodes, multi-factor authentication tokens, etc.).

Upon detecting the contactless card within a predetermined area of the mobile device, the mobile device may request and/or be automatically provided with various identification data from the contactless card. The identification data may include various information identifying the card and/or user of the card. It may include one or more identifiers that may be used to identify the card. The contactless card may also transmit various contactless card data. The contactless card data may include the contactless card data includes at least one of the following: an account number associated with the contactless card, an expiration date associated with the contactless card, a card verification value (CVV) associated with the contactless card, a billing address associated with the contactless card, a name of a user associated with the contactless card, and any combination thereof. The mobile device may then transmit the received identification data to one or more servers that may be communicatively coupled to the mobile device.

The server(s) may store information associated with the card, the user that it is issued to, security and/or authentication information, tokens that may be necessary to activate the card, and/or any other information. Alternatively, or in addition to, the information may be stored in one or more storage locations (e.g., a database) that the server(s) may query and retrieve data that the server(s) may need for processing. The server(s) may process the data received from the mobile device. This may include decrypting any data that may have been encrypted by the mobile device prior to sending to the server, extracting information from data packets that are received from the mobile device, comparing the received information with data that the server(s) may have stored and/or extracted from a storage location, and generating a response as a result of the comparison, and/or any other operations. The response may include generation of an authentication data authenticating the contactless card and/or generation of an error/alert indicating that the contactless card has not been authenticated and hence, further operations may be prevented. Alternatively, or in addition, the server(s) may transmit a request to the mobile device to request the contactless card to provide further and/or different information for authentication at the server(s).

If the contactless card has been authenticated, the mobile device may trigger execution of a mobile application for the purposes of electronically transferring funds to an account associated with the contactless card. The mobile application may be configured to generate one or more user interface screens that may display one or more fillable fields, which may be automatically populated based on the contactless card data received from the contactless card and/or the authentication data received from the server(s). In some implementations, the funds (e.g., a previously defined amount) may be automatically transferred to the account associated with the contactless card and/or the user of the mobile device may enter an amount of funds to be transferred in a designated field. In some example implementations, the contactless card includes at least one of the following: a credit card, a debit card, an electronic gift card, a pre-paid credit card, a pre-paid debit card, and any combination thereof.

In some example implementations, the contactless card may instead be another or second mobile device and one or more of the above processes may be executed using a peer-to-peer NFC exchange communication. Each mobile device may be associated with its own electronic deposit account, whereby upon receiving of appropriate authentication data from the server(s) authenticating the second mobile device, the first mobile device may be configured to trigger an electronic transfer of funds from its associated deposit account to an electronic deposit account associated with the second mobile device.

In some examples, non-limiting implementations, the current subject matter may be configured to improve the speed and/or ease of payment and/or transfer of funds from one account to another. It may also reduce a risk of fraud by not requiring users to carry their cards with them. Moreover, the current subject matter may be configured to improve an overall hygiene of execution of transactions by reducing a number of points of germ transfer, as well as provide various other benefits.

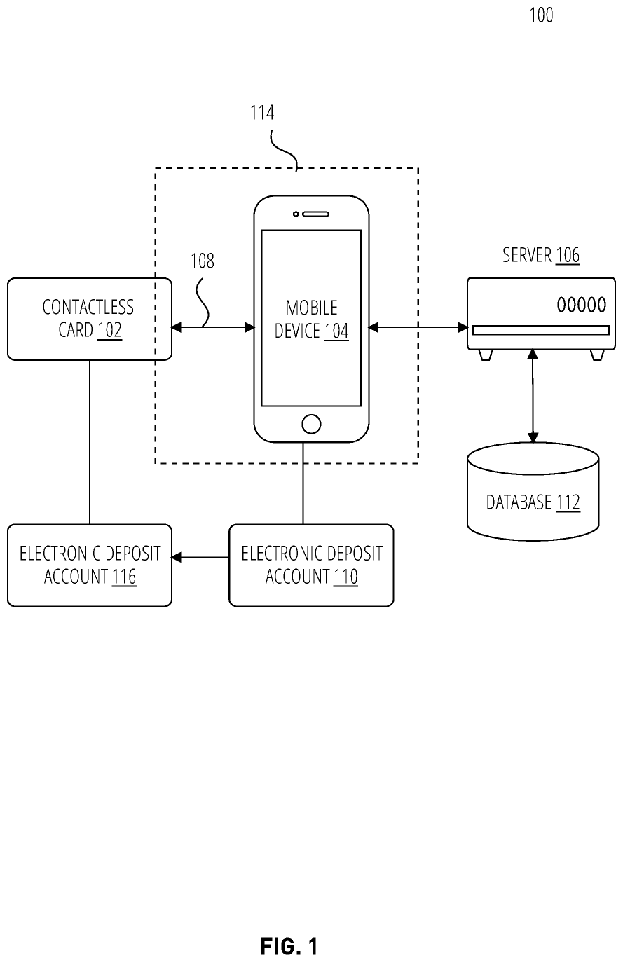

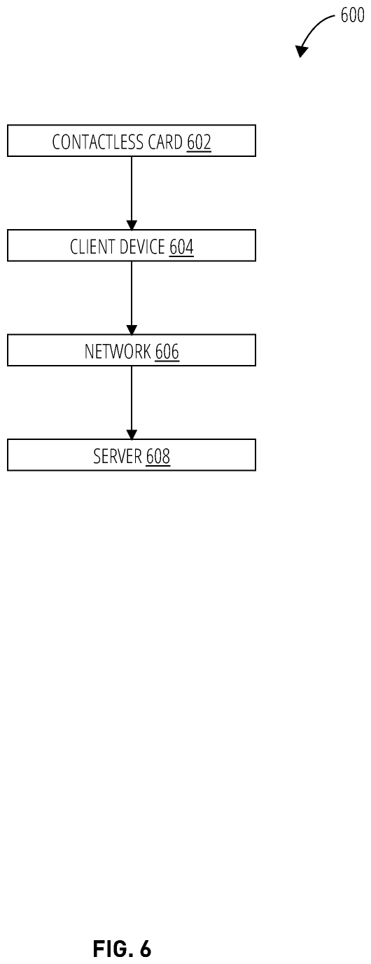

FIG. 1 illustrates an exemplary system 100 for executing one or more transactions, according to some implementations of the current subject matter. The system 100 may include a contactless card 102, a mobile device 104, a server 106, an electronic deposit account 110, an electronic deposit account 116, and a database 112. The contactless card 102 may have one or more features discussed below in connection with FIGS. 6-15. The mobile device 104 may be configured to have a predetermined area or geofence 114 that may be configured to surround the mobile device 104. The mobile device 104 may be configured to detect one or more objects, such as, the contactless card 102, upon entry of the object into the predetermined area 114. Alternatively, or in addition, the mobile device 104 may be configured to detect such an object upon the object being positioned within a predetermined distance away from the mobile device 104, where the predetermined distance may be defined by the area 114.

One or more components of the system 100 may be communicatively coupled using one or more communications networks. The communications networks may include one or more of the following: a wired network, a wireless network, a metropolitan area network (“MAN”), a local area network (“LAN”), a wide area network (“WAN”), a virtual local area network (“VLAN”), an internet, an extranet, an intranet, and/or any other type of network and/or any combination thereof.

Further, one or more components of the system 100 may include any combination of hardware and/or software. In some implementations, one or more components of the system 100 may be disposed on one or more computing devices, such as, server(s), database(s), personal computer(s), laptop(s), cellular telephone(s), smartphone(s), tablet computer(s), virtual reality devices, and/or any other computing devices and/or any combination thereof. In some example implementations, one or more components of the system 100 may be disposed on a single computing device and/or may be part of a single communications network. Alternatively, or in addition to, such services may be separately located from one another. A service may be a computing processor, a memory, a software functionality, a routine, a procedure, a call, and/or any combination thereof that may be configured to execute a particular function associated with the current subject matter lifecycle orchestration service(s).

In some implementations, the system 100's one or more components may include network-enabled computers. As referred to herein, a network-enabled computer may include, but is not limited to a computer device, or communications device including, e.g., a server, a network appliance, a personal computer, a workstation, a phone, a smartphone, a handheld PC, a personal digital assistant, a thin client, a fat client, an Internet browser, or other device. One or more components of the system 100 also may be mobile computing devices, for example, an iPhone, iPod, iPad from Apple® and/or any other suitable device running Apple's iOS® operating system, any device running Microsoft's Windows®. Mobile operating system, any device running Google's Android® operating system, and/or any other suitable mobile computing device, such as a smartphone, a tablet, or like wearable mobile device.

One or more components of the system 100 may include a processor and a memory, and it is understood that the processing circuitry may contain additional components, including processors, memories, error and parity/CRC checkers, data encoders, anti-collision algorithms, controllers, command decoders, security primitives and tamper-proofing hardware, as necessary to perform the functions described herein. One or more components of the environment 100 may further include one or more displays and/or one or more input devices. The displays may be any type of devices for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some example implementations, one or more components of the environment 100 may execute one or more applications, such as software applications, that enable, for example, network communications with one or more components of environment 100 and transmit and/or receive data.

One or more components of the environment 100 may include and/or be in communication with one or more servers via one or more networks and may operate as a respective front-end to back-end pair with one or more servers. One or more components of the environment 100 may transmit, for example from a mobile device application (e.g., executing on one or more user devices, components, etc.), one or more requests to one or more servers (e.g., server(s) 106). The requests may be associated with retrieving data from servers. The servers may receive the requests from the components of the system 100. Based on the requests, servers may be configured to retrieve the requested data from one or more databases (e.g., storage 112 as shown in FIG. 1). Based on receipt of the requested data from the databases, the servers may be configured to transmit the received data to one or more components of the system 100, where the received data may be responsive to one or more requests.

The system 100 may include one or more networks. In some implementations, networks may be one or more of a wireless network, a wired network or any combination of wireless network and wired network and may be configured to connect the components of the system 100 and/or the components of the system 100 to one or more servers. For example, the networks may include one or more of a fiber optics network, a passive optical network, a cable network, an Internet network, a satellite network, a wireless local area network (LAN), a metropolitan area network (MAN), a wide area network (WAN), a virtual local area network (VLAN), an extranet, an intranet, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or any other type of network and/or any combination thereof.

In addition, the networks may include, without limitation, telephone lines, fiber optics, IEEE Ethernet 802.3, a wide area network, a wireless personal area network, a LAN, or a global network such as the Internet. Further, the networks may support an Internet network, a wireless communication network, a cellular network, or the like, or any combination thereof. The networks may further include one network, or any number of the exemplary types of networks mentioned above, operating as a stand-alone network or in cooperation with each other. The networks may utilize one or more protocols of one or more network elements to which they are communicatively coupled. The networks may translate to or from other protocols to one or more protocols of network devices. The networks may include a plurality of interconnected networks, such as, for example, the Internet, a service provider's network, a cable television network, corporate networks, such as credit card association networks, and home networks.

The system 100 may include one or more servers, which may include one or more processors that maybe coupled to memory. Servers may be configured as a central system, server or platform to control and call various data at different times to execute a plurality of workflow actions. Servers may be configured to connect to the one or more databases. Servers may be incorporated into and/or communicatively coupled to at least one of the components of the system 100.

One or more components of the system 100 may be configured to execute one or more transactions using one or more containers. In some implementations, each transaction may be executed using its own container. A container may refer to a standard unit of software that may be configured to include the code that may be needed to execute the action along with all its dependencies. This may allow execution of actions to run quickly and reliably.

In some implementations, as discussed above, the system 100 may be used for execution of various transactions using the contactless card 102. In particular, the transactions may be executed using near-field communications (NFC) exchange link 108 between the contactless card 102 and the mobile device 104. To enable use of the NFC technology, a user (not shown in FIG. 1) may bring the contactless card 102 within the area 114 of the mobile device 104 (e.g., tap the card 102 on the mobile device 104), whereby the mobile device 104 may be configured to detect presence of the contactless card 102 within the area 114 and execute one or more operations discussed herein. For example, the NFC 108 may be used in connection with payment transactions, “refilling” a prepaid card, a gift card, etc. where funds may be transferred from the electronic deposit account 110 associated with the mobile device 104 to a deposit account 116 associated with the contactless card 102.

In the NFC exchange link 108, the mobile device 104 may be configured to act as an active component and provide power to energize the contactless card 102 (as discussed herein), which may be a passive component. Using the link 108, the mobile device 104 and the contactless card 102 may be configured to exchange various data, such as, for instance, for the purposes of transferring funds from account 110 associated with the mobile device 104 to account 116 associated with the contactless card 102. As discussed herein, the mobile device 104 may be securely linked to the account 110 at a financial institution that may have available funds deposited therein (e.g., a checking account, a savings account, etc.). The contactless card 102 may likewise be securely linked to account 116. The linking of the mobile device 104 and the deposit account 110 may be configured to allow the mobile device 104 to request transfer of funds from the deposit account 110 to any desired destination, such as, for example, the contactless card 102's account 116 (and/or, for instance, another account, a prepaid card, a gift card, etc.). Access to the account from the mobile device may be secured/protected using various authentication/authorization mechanisms (e.g., username and password, user biometrics, passcodes, multi-factor authentication tokens, etc.).

Once the mobile device 104 detected the contactless card 102 within the area 114, the mobile device 104, using the NFC link 108, may be configured to request and/or be automatically provided with various identification data from the contactless card 102. The identification data may include various information identifying the card and/or the user of the card (e.g., one or more identifiers, etc.).

In some example implementations, the contactless card 102 may be configured to transmit contactless card data that may be stored on the card. Examples of the contactless card data may include an account number associated with the contactless card, an expiration date associated with the contactless card, a card verification value (CVV) associated with the contactless card, a billing address associated with the contactless card, a name of a user associated with the contactless card, etc.

Once the data is received from the contactless card 102, the mobile device 104 may transmit the received identification data to the server 106 for processing. Transmission of data to the server 106 may be via any desired type of network. The mobile device 104 may be configured to transmit data to the server 106 in one or more data packets.

The server 106 may be configured to store various data associated with the contactless card 102, the user that it is issued to, security and/or authentication information, tokens that may be used for activation and/or use of the card, etc. In some example implementations, the server 106 may also issue a query to the database 112, which may store some and/or all of the above and/or any other information related to the contactless card 102. The query may be used to search the database 112 to retrieve requested data. The data stored by the server 106 and/or in the database 112 may have been previously stored, such as, for example, when the contactless card 102 has been issued and/or manufactured by the issuer of the card.

The server 106 may process the data packets received from the mobile device 104. In some implementations, the data packets received from the mobile device 104 may be encrypted and thus, the server 106 may execute various decryption algorithms to decrypt the received data. Once the data packets have been decrypted, the server 106 may extract information from the data packets and then compare the extracted with data that may have been stored by the server 106 and/or database 112. If the server 106 determines that there is a match between the stored data and the received data, the server 106 may be configured to generate an authentication data that may be configured to authenticate the contactless card 102 and transmit such authentication data to the mobile device 104.

However, if the server 106 fails to determine a match, it may generate an error/alert and transmit it to the mobile device 104. The error/alert may indicate that the contactless card has not been authenticated and hence, further operations (e.g., transfer of funds to an account associated with the card 102) may be prevented. In some example implementations, the server 106 may transmit a request to the mobile device 104 to prompt the contactless card 102 to provide further and/or different information for authentication at the server 104.

Upon receiving of the authentication of the contactless card 102, the mobile device 104 may automatically trigger execution of a mobile application (not shown in FIG. 1) that may be used to electronically transfer funds from a financial institution account associated with the mobile device 104 to a financial institution account associated with the contactless card 102 (e.g., a parent may use this process to transfer funds from parent's banking account to child's banking account associated with the card).

The mobile application may be configured to generate one or more user interfaces on the mobile device 104. The user interfaces may include one or more fillable fields, which may be automatically populated based on the contactless card data received from the contactless card 102 and/or the authentication data received from the server 106. Further, the funds (e.g., a previously defined amount) may be automatically transferred to the account associated with the contactless card 102 and/or the user of the mobile device 104 may enter an amount of funds to be transferred in one or more designated fields.

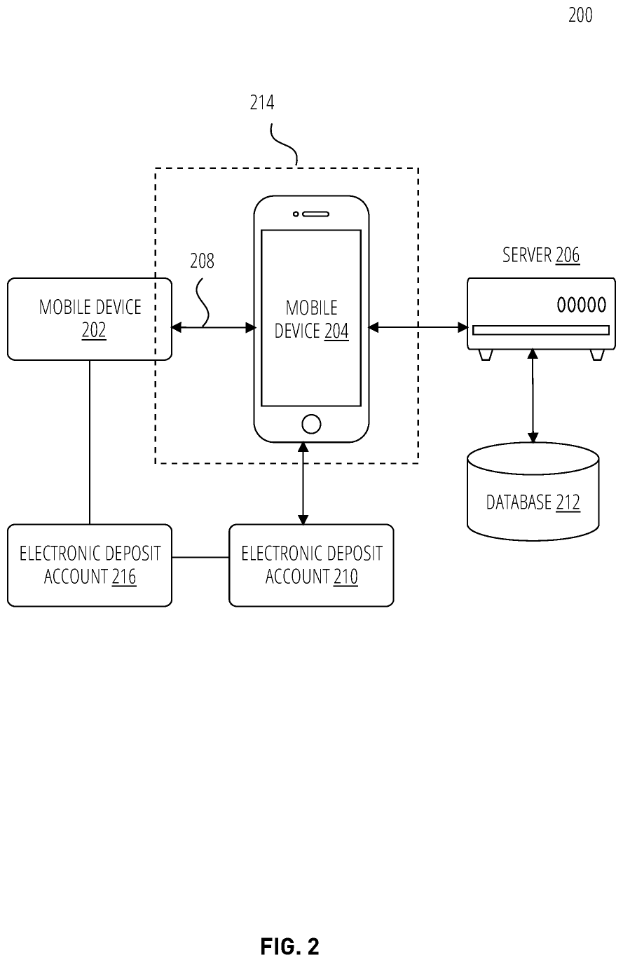

As discussed above, another or second mobile device 202, as shown in FIG. 2, may be used instead of the contactless card 102 (shown in FIG. 1), to execute one or more operations discussed in connection with FIG. 1. In particular, FIG. 2 illustrates an exemplary system 200, according to some implementations of the current subject matter, which uses a peer-to-peer NFC exchange communication 208. In addition to using another mobile device 202, the system 200, similar to the system 100, may include a mobile device 204, a server 206, an electronic deposit account 210, and a database 212. The components of the system 200 may likewise be communicatively coupled using one or more networks discussed above. The operations discussed in connection with FIG. 1 may be performed upon the mobile device 202 coming within a predetermined area 214 of the mobile device 204 (and/or vice-versa).

Further, each mobile device 202, 204 may be associated with its own electronic deposit account 216, 210, respectively. Transfer of funds between accounts 210, 216 may be executed upon receiving appropriate authentication data from the server 206 that may authenticate the mobile device 202. In this case, the mobile device 204 may trigger an electronic transfer of funds from the deposit account 210 associated with it to the electronic deposit account 216 associated with the mobile device 202.

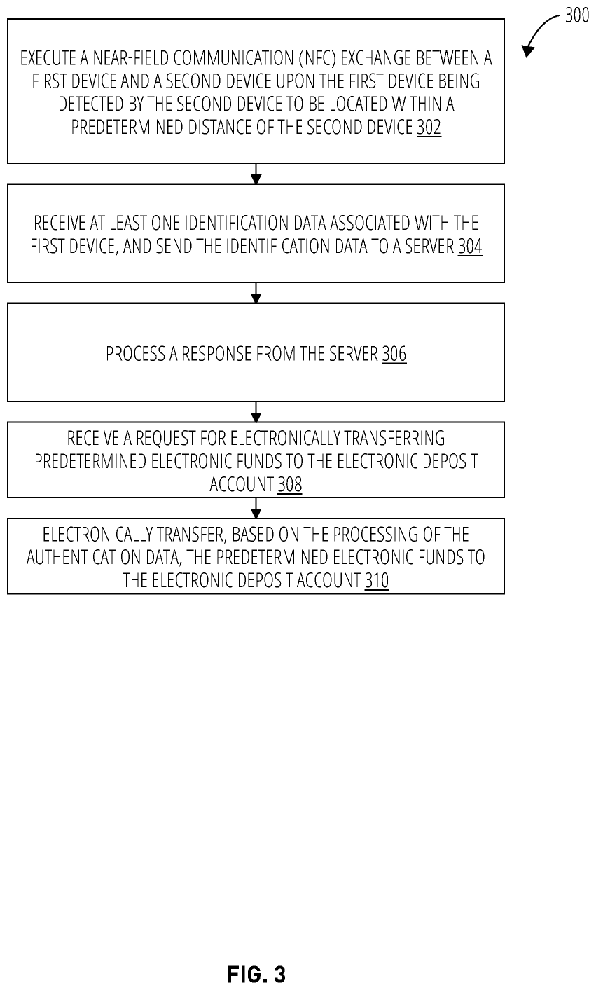

FIG. 3 illustrates an exemplary process 300 for execution of a transaction, according to some implementations of the current subject matter. The process 300 may be executed by the system 100 shown in FIG. 1 and/or system 200 shown in FIG. 2.

At 302, a first device (e.g., a contactless card 102 and/or mobile device 202) and a second device (e.g., a mobile device 104 and/or 204) may be configured to execute a near-field communication (NFC) exchange. Such exchange may be accomplished via the link 108 and/or 208 upon the first device and/or the second device being proximate to one another so that the second device may be able to detect by the first device being located within a predetermined distance (e.g., area 114, 214) of the second device. The first device may be associated with an electronic deposit account capable of receiving an electronic transfer of funds.

At 304, the second device may receive at least one identification data associated with the first device, and send the identification data to the server(s) 106, 206. The identification data may be received from the first device using the NFC exchange 108, 208.

The server may process the received identification data and generate a response, at 306. The response may include an authentication data corresponding to the first device and associated with the identification data. In connection with the processing of the response by the server, the server may perform decryption of any encrypted authentication data corresponding to the contactless card. It may also determine, based on the decrypted data, that the contactless card has been authenticated by the server. As such, electronic transfer of the funds from one account to another may be performed. Otherwise, if the contactless card has not been authenticated by the server, any further transactions, including the electronic transfer of funds, may be prevented.

At 308, a request for electronically transferring predetermined electronic funds to the electronic deposit account associated with the contactless card (e.g., account 116, 216) may be received, and, as a result of the processing of the data by the server, the transfer of the funds from an account associated with the mobile device to the account associated with the contactless card may be performed, at 310.

In some implementations, as a result of the execution of the NFC exchange (e.g., links 108, 208), the mobile device may be configured to automatically trigger execution of an application for performing the electronic transfer of funds. The application may be configured to generate one or more user interfaces that may include one or more form fields. The fields may be manually filled in and/or automatically populated using the contactless card data received during the NFC exchange. The contactless card data may include an account number associated with the contactless card, an expiration date associated with the contactless card, a card verification value (CVV) associated with the contactless card, a billing address associated with the contactless card, a name of a user associated with the contactless card, and/or any other data.

As discussed above, the contactless card used during the process 300 may be a credit card, a debit card, an electronic gift card, a pre-paid credit card, a pre-paid debit card, and/or any other type of card. Alternatively, or in addition, instead of the contactless card, another mobile device (e.g., device 202 as shown in FIG. 2) may be configured to communicate with the mobile device 204 for the purposes of electronic funds transfer.

In some implementations, electronic funds transfer may be executed using a server (e.g., server 106, 206), rather than the mobile device (e.g., device 104, 204). For example, the request received by the mobile device to transfer funds to an account associated with the contactless card/another mobile device may be transmitted to the server. Upon receiving the request, the server may communicate the request to at least another electronic deposit account storing the predetermined electronic funds (e.g., the account 110, 210). The funds transfer may then be executed as a result of receiving instructions from the server.

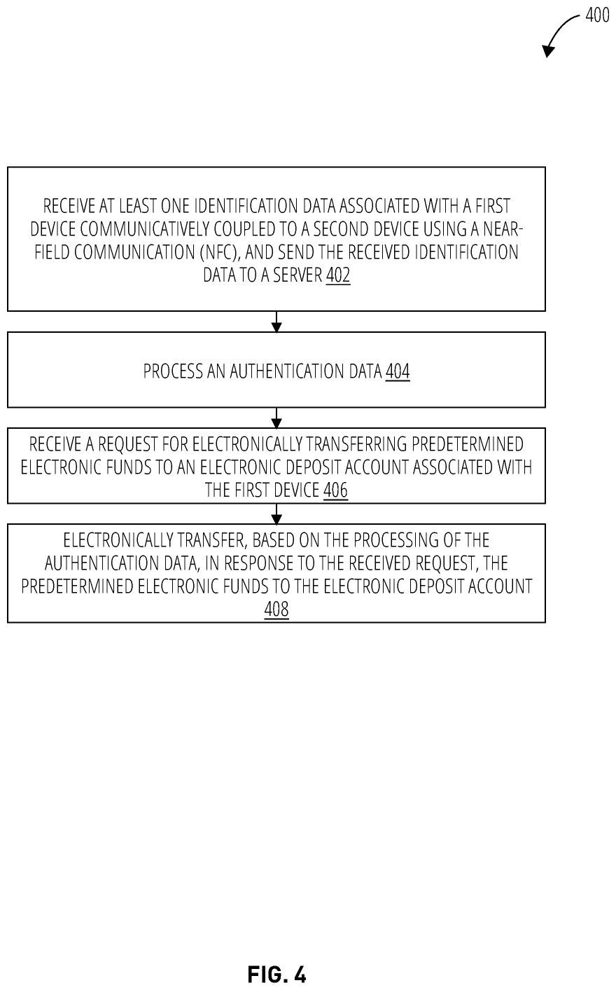

FIG. 4 illustrates another exemplary process 400 for execution of a transaction, according to some implementations of the current subject matter. The process 400 may be executed by the system 100 shown in FIG. 1 and/or system 200 shown in FIG. 2.

At 402, at least one identification data associated with a first device (e.g., contactless card 102 and/or mobile device 202, etc.) may be received by a second device (e.g., mobile device 104, 204) that maybe communicatively coupled to the first device using a near-field communication (NFC) link (e.g., link 108, 208). The received identification data may be sent to a server (e.g., server 106, 206). Transmission of the identification data from the first device to the second device may be triggered as a result of the creation of the NFC exchange link between the first device and the second device.

At 404, the server may be configured to generate an authentication data based on the identification data. The authentication data may be configured to indicate that the server has authenticated the first device (alternatively, the authentication data may indicate that the server was not able to authenticate the first device). The second device may be configured to process the received authentication data for the purposes of executing an electronic transfer of funds from one deposit account (e.g., account 110, 210) to another deposit account (e.g., account 116, 216).

Subsequently, the second device may be configured to receive a request to electronically transfer a predetermined amount of electronic funds to an electronic deposit account associated with the first device (e.g., account 116, 216), at 406. Using the received authentication data, at 408, the second device may cause an electronic transfer of the requested electronic funds to the specified electronic deposit account (e.g., account 116, 216).

FIG. 4 illustrates yet another exemplary process 500 for execution of a transaction, according to some implementations of the current subject matter. The process 500 may be executed by the system 100 shown in FIG. 1 and/or system 200 shown in FIG. 2.

At 502, at least one communication may be sent/transmitted, using a near-field communication (NFC) exchange link (e.g., link 108, 208), by a second device (e.g., device 104, 204) between a first device (e.g., device 102, 202) and the second device upon the first device being detected by the second device (e.g., within a predetermined area 114, 214). The first device may be associated with an electronic deposit account (e.g., account 110, 210) and may be configured to receive an electronic transfer of funds.

At least one identification data associated with the first device may be sent/transmitted to a server (e.g., server 106, 206), at 504. The identification data may be received from the first device in response to the communication exchanged between the first device and the second device.

The server may generate a response to the received identification data. The response may be indicative of whether the first device has or has not been authenticated. The second device may then process the response from the server, at 506 and determine whether to electronically transfer, based on the processed authentication data, a specified/predetermined amount of electronic funds to the electronic deposit account (e.g., account 110, 210).

FIG. 6 illustrates a data transmission system 600, according to some implementations of the current subject matter. As further discussed below, system 600 may include contactless card 602, client device 604, network 606, and server 608. Although FIG. 6 illustrates single instances of the components, system 600 may include any number of components.

System 600 may include one or more contactless cards 602, which are further explained below. In some embodiments, contactless card 602 may be in wireless communication, utilizing NFC in an example, with client device 604.

System 600 may include client device 604, which may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device, client device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 604 device can include a processor and a memory, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein.

In some implementations, client device 604 of system 600 may execute one or more applications, such as software applications, that enable, for example, network communications with one or more components of system 600 and transmit and/or receive data.

The client device 604 may be in communication with one or more server(s) 608 via one or more network(s) 606, and may operate as a respective front-end to back-end pair with server 608. The client device 604 may transmit, for example from a mobile device application executing on client device 604, one or more requests to server 608. The one or more requests may be associated with retrieving data from server 608. The server 608 may receive the one or more requests from client device 604. Based on the one or more requests from client device 604, server 608 may be configured to retrieve the requested data from one or more databases (not shown). Based on receipt of the requested data from the one or more databases, server 608 may be configured to transmit the received data to client device 604, the received data being responsive to one or more requests.

System 600 may include one or more networks 606. In some implementations, network 606 may be one or more of a wireless network, a wired network or any combination of wireless network and wired network, and may be configured to connect client device 604 to server 608. For example, network 606 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 1302.11 family of networking, Bluetooth, NFC, Radio Frequency Identification (RFID), Wi-Fi, and/or the like.

In addition, network 606 may include, without limitation, telephone lines, fiber optics, IEEE Ethernet 802.3, a wide area network, a wireless personal area network, a LAN, or a global network such as the Internet. In addition, network 606 may support an Internet network, a wireless communication network, a cellular network, or the like, or any combination thereof. network 606 may further include one network, or any number of the exemplary types of networks mentioned above, operating as a stand-alone network or in cooperation with each other. network 606 may utilize one or more protocols of one or more network elements to which they are communicatively coupled, network 606 may translate to or from other protocols to one or more protocols of network devices. Although network 606 is depicted as a single network, it should be appreciated that according to one or more examples, network 606 may comprise a plurality of interconnected networks, such as, for example, the Internet, a service provider's network, a cable television network, corporate networks, such as credit card association networks, and home networks.

System 600 may include one or more servers 608. In some implementations, server 608 may include one or more processors, which are coupled to memory. The server 608 may be configured as a central system, server or platform to control and call various data at different times to execute a plurality of workflow actions. Server 120 may be configured to connect to the one or more databases. The server 608 may be connected to at least one client device 604.

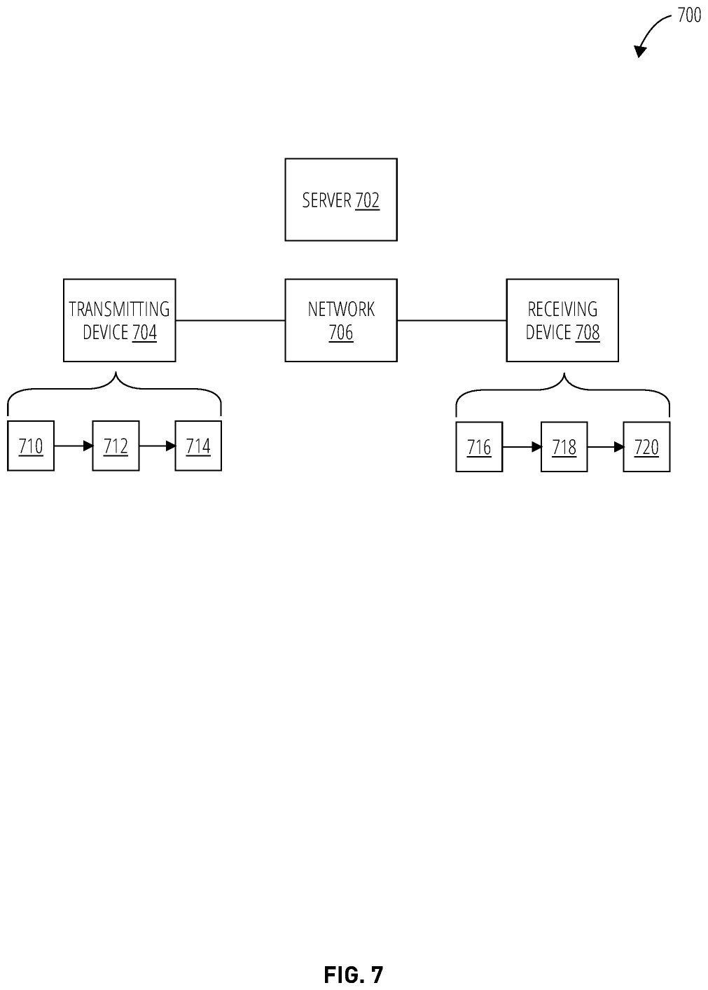

FIG. 7 illustrates a data transmission system, according to some implementations of the current subject matter. System 700 may include a transmitting or transmitting device 704, a receiving or receiving device 708 in communication, for example via network 706, with one or more servers 702. Transmitting or transmitting device 704 may be the same as, or similar to, client device 110 discussed above with reference to FIG. 1A. Receiving or receiving device 708 may be the same as, or similar to, client device 110 discussed above with reference to FIG. 1A. Network 706 may be similar to network 115 discussed above with reference to FIG. 1A. Server 702 may be similar to server 120 discussed above with reference to FIG. 1A. Although FIG. 7 shows single instances of components of system 700, system 700 may include any number of the illustrated components.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be compromised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 7, system 700 may be configured to implement key diversification. For example, a sender and recipient may desire to exchange data (e.g., original sensitive data) via respective devices 704 and 708. As explained above, although single instances of transmitting device 704 and receiving device 708 may be included, it is understood that one or more transmitting devices 704 and one or more receiving devices 708 may be involved so long as each party shares the same shared secret symmetric key. In some implementations, the transmitting device 704 and receiving device 708 may be provisioned with the same master symmetric key. Further, it is understood that any party or device holding the same secret symmetric key may perform the functions of the transmitting device 704 and similarly any party holding the same secret symmetric key may perform the functions of the receiving device 708. In some implementations, the symmetric key may comprise the shared secret symmetric key which is kept secret from all parties other than the transmitting device 704 and the receiving device 708 involved in exchanging the secure data. It is further understood that both the transmitting device 704 and receiving device 708 may be provided with the same master symmetric key, and further that part of the data exchanged between the transmitting device 704 and receiving device 708 comprises at least a portion of data which may be referred to as the counter value. The counter value may comprise a number that changes each time data is exchanged between the transmitting device 704 and the receiving device 708.

System 700 may include one or more networks 706. In some implementations, network 706 may be one or more of a wireless network, a wired network or any combination of wireless network and wired network, and may be configured to connect one or more transmitting devices 704 and one or more receiving devices 708 to server 702. For example, network 706 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 1302.11 family network, Bluetooth, NFC, RFID, Wi-Fi, and/or the like.

In addition, network 706 may include, without limitation, telephone lines, fiber optics, IEEE Ethernet 1402.3, a wide area network, a wireless personal area network, a LAN, or a global network such as the Internet. In addition, network 706 may support an Internet network, a wireless communication network, a cellular network, or the like, or any combination thereof. Network 706 may further include one network, or any number of the exemplary types of networks mentioned above, operating as a stand-alone network or in cooperation with each other. Network 706 may utilize one or more protocols of one or more network elements to which they are communicatively coupled. Network 706 may translate to or from other protocols to one or more protocols of network devices. Although network 706 is depicted as a single network, it should be appreciated that according to one or more examples, network 706 may comprise a plurality of interconnected networks, such as, for example, the Internet, a service provider's network, a cable television network, corporate networks, such as credit card association networks, and home networks.

In some implementations, one or more transmitting devices 704 and one or more receiving devices 708 may be configured to communicate and transmit and receive data between each other without passing through network 706. For example, communication between the one or more transmitting devices 704 and the one or more receiving devices 708 may occur via at least one of NFC, Bluetooth, RFID, Wi-Fi, and/or the like.

At 710, when the transmitting device 704 is preparing to process the sensitive data with symmetric cryptographic operation, the sender may update a counter. In addition, the transmitting device 704 may select an appropriate symmetric cryptographic algorithm, which may include at least one of a symmetric encryption algorithm, HMAC algorithm, and a CMAC algorithm. In some implementations, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At 712, the transmitting device 704 may take the selected cryptographic algorithm, and using the master symmetric key, process the counter value. For example, the sender may select a symmetric encryption algorithm, and use a counter which updates with every conversation between the transmitting device 704 and the receiving device 708. The transmitting device 704 may then encrypt the counter value with the selected symmetric encryption algorithm using the master symmetric key, creating a diversified symmetric key.

In some implementations, the counter value may not be encrypted. In these examples, the counter value may be transmitted between the transmitting device 704 and the receiving device 708 at block 712 without encryption.

At 714, the diversified symmetric key may be used to process the sensitive data before transmitting the result to the receiving device 708. For example, the transmitting device 704 may encrypt the sensitive data using a symmetric encryption algorithm using the diversified symmetric key, with the output comprising the protected encrypted data. The transmitting device 704 may then transmit the protected encrypted data, along with the counter value, to the receiving device 708 for processing.

At 716, the receiving device 708 may first take the counter value and then perform the same symmetric encryption using the counter value as input to the encryption, and the master symmetric key as the key for the encryption. The output of the encryption may be the same diversified symmetric key value that was created by the sender.

At 718, the receiving device 708 may then take the protected encrypted data and using a symmetric decryption algorithm along with the diversified symmetric key, decrypt the protected encrypted data.

At 720, as a result of decrypting the protected encrypted data, the original sensitive data may be revealed.

The next time sensitive data needs to be sent from the sender to the recipient via respective transmitting device 704 and receiving device 708, a different counter value may be selected producing a different diversified symmetric key. By processing the counter value with the master symmetric key and same symmetric cryptographic algorithm, both the transmitting device 704 and receiving device 708 may independently produce the same diversified symmetric key. This diversified symmetric key, not the master symmetric key, is used to protect the sensitive data.

As explained above, both the transmitting device 704 and receiving device 708 each initially possess the shared master symmetric key. The shared master symmetric key is not used to encrypt the original sensitive data. Because the diversified symmetric key is independently created by both the transmitting device 704 and receiving device 708, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 704 and the receiving device 708 may be governed by symmetric requirements for how often to create a new diversification value, and therefore a new diversified symmetric key. In some implementations, a new diversification value and therefore a new diversified symmetric key may be created for every exchange between the transmitting device 704 and receiving device 708.

In some implementations, the key diversification value may comprise the counter value. Other non-limiting examples of the key diversification value include: a random nonce generated each time a new diversified key is needed, the random nonce sent from the transmitting device 704 to the receiving device 708; the full value of a counter value sent from the transmitting device 704 and the receiving device 708; a portion of a counter value sent from the transmitting device 704 and the receiving device 708; a counter independently maintained by the transmitting device 704 and the receiving device 708 but not sent between the two devices; a one-time-passcode exchanged between the transmitting device 704 and the receiving device 708; and a cryptographic hash of the sensitive data. In some implementations, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 704 and the receiving device 708. In effect, this may create a one-time use key, such as a single-use session key.

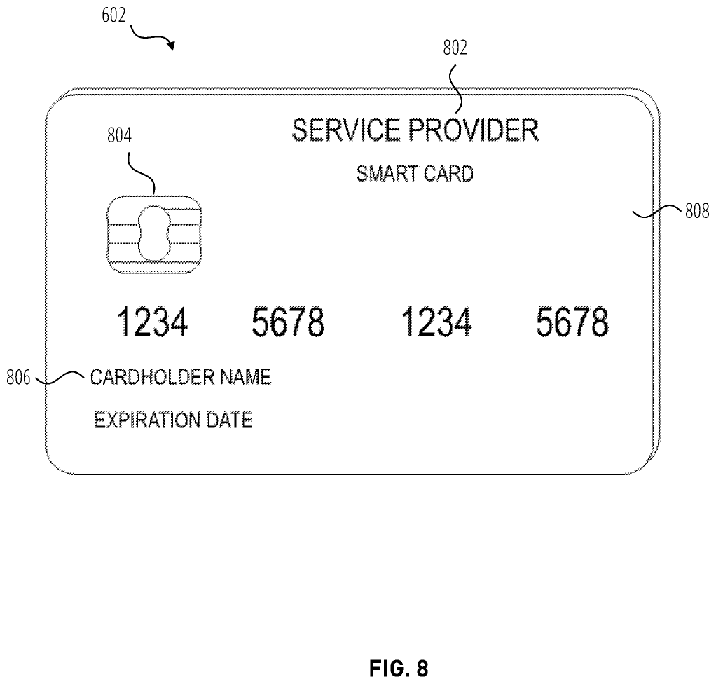

FIG. 8 illustrates an example configuration of a contactless card 602, which may include a contactless card, a payment card, such as a credit card, debit card, or gift card, issued by a service provider as displayed as service provider indicia 802 on the front or back of the contactless card 602, according to some implementations of the current subject matter. In some implementations, the contactless card 602 is not related to a payment card, and may include, without limitation, an identification card. In some implementations, the transaction card may include a dual interface contactless payment card, a rewards card, and so forth. The contactless card 602 may include a substrate 808, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some implementations, the contactless card 602 may have physical characteristics compliant with the ID-1 format of the ISO/IEC 7816 standard, and the transaction card may otherwise be compliant with the ISO/IEC 14443 standard. However, it is understood that the contactless card 602 according to the present disclosure may have different characteristics, and the present disclosure does not require a transaction card to be implemented in a payment card.

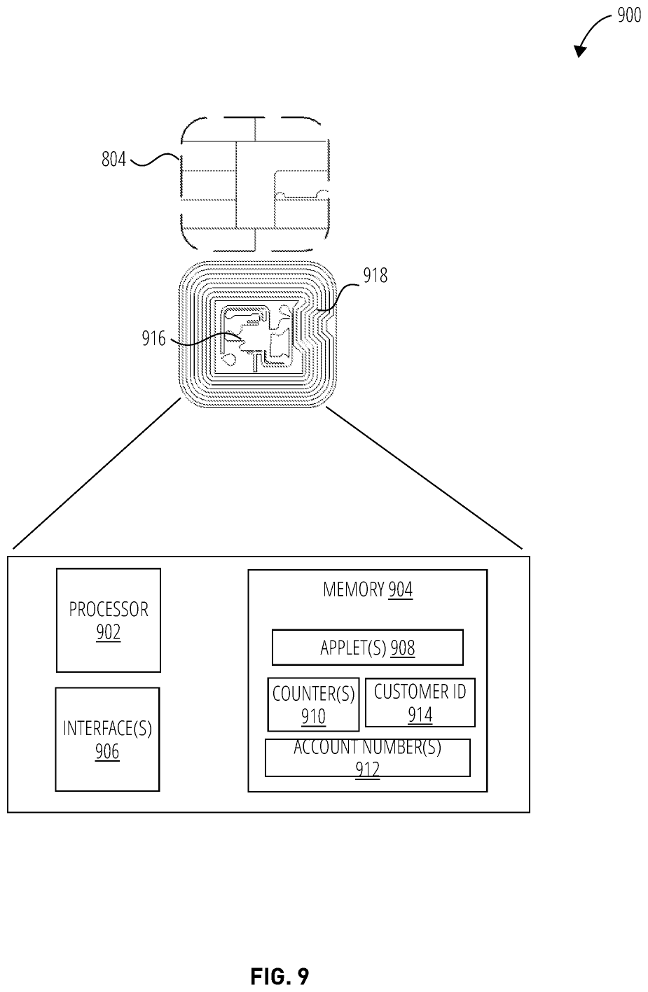

The contactless card 602 may also include identification information 806 displayed on the front and/or back of the card, and a contact pad 804. The contact pad 804 may include one or more pads and be configured to establish contact with another client device, such as an ATM, a user device, smartphone, laptop, desktop, or tablet computer via transaction cards. The contact pad may be designed in accordance with one or more standards, such as ISO/IEC 7816 standard, and enable communication in accordance with the EMV protocol. The contactless card 602 may also include processing circuitry, antenna and other components as will be further discussed in FIG. 9. These components may be located behind the contact pad 804 or elsewhere on the substrate 808, e.g., within a different layer of the substrate 808, and may electronically and physically coupled with the contact pad 804. The contactless card 602 may also include a magnetic strip or tape, which may be located on the back of the card (not shown in FIG. 8). The contactless card 602 may also include a Near-Field Communication (NFC) device coupled with an antenna capable of communicating via the NFC protocol. Embodiments are not limited in this manner.

As illustrated in FIG. 2, the contact pad 804 of contactless card 602 may include processing circuitry 916 for storing, processing, and communicating information, including a processor 902, a memory 904, and one or more interface(s) 906. It is understood that the processing circuitry 916 may contain additional components, including processors, memories, error and parity/CRC checkers, data encoders, anticollision algorithms, controllers, command decoders, security primitives and tamperproofing hardware, as necessary to perform the functions described herein.

The memory 904 may be a read-only memory, write-once read-multiple memory or read/write memory, e.g., RAM, ROM, and EEPROM, and the contactless card 602 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory. In some instances, the memory 904 may be encrypted memory utilizing an encryption algorithm executed by the processor 902 to encrypted data.

The memory 904 may be configured to store one or more applet(s) 908, one or more counter(s) 910, a customer identifier 914, and the account number(s) 912, which may be virtual account numbers. The one or more applet(s) 908 may comprise one or more software applications configured to execute on one or more contactless cards, such as a Java® Card applet. However, it is understood that applet(s) 908 are not limited to Java Card applets, and instead may be any software application operable on contactless cards or other devices having limited memory. The one or more counter(s) 910 may comprise a numeric counter sufficient to store an integer. The customer identifier 914 may comprise a unique alphanumeric identifier assigned to a user of the contactless card 602, and the identifier may distinguish the user of the contactless card from other contactless card users. In some implementations, the customer identifier 914 may identify both a customer and an account assigned to that customer and may further identify the contactless card 602 associated with the customer's account. As stated, the account number(s) 912 may include thousands of one-time use virtual account numbers associated with the contactless card 602. An applet(s) 908 of the contactless card 602 may be configured to manage the account number(s) 912 (e.g., to select an account number(s) 912, mark the selected account number(s) 912 as used, and transmit the account number(s) 912 to a mobile device for autofilling by an autofilling service.

The processor 902 and memory elements of the foregoing exemplary embodiments are described with reference to the contact pad 804, but the present disclosure is not limited thereto. It is understood that these elements may be implemented outside of the contact pad 804 or entirely separate from it, or as further elements in addition to processor 902 and memory 904 elements located within the contact pad 804.

In some implementations, the contactless card 602 may comprise one or more antenna(s) 918. The one or more antenna(s) 918 may be placed within the contactless card 602 and around the processing circuitry 916 of the contact pad 804. For example, the one or more antenna(s) 918 may be integral with the processing circuitry 916 and the one or more antenna(s) 918 may be used with an external booster coil. As another example, the one or more antenna(s) 918 may be external to the contact pad 804 and the processing circuitry 916.

In some implementations, the coil of contactless card 602 may act as the secondary of an air core transformer. The terminal may communicate with the contactless card 602 by cutting power or amplitude modulation. The contactless card 101 may infer the data transmitted from the terminal using the gaps in the contactless card's power connection, which may be functionally maintained through one or more capacitors. The contactless card 602 may communicate back by switching a load on the contactless card's coil or load modulation. Load modulation may be detected in the terminal's coil through interference. More generally, using the antenna(s) 918, processor 902, and/or the memory 904, the contactless card 101 provides a communications interface to communicate via NFC, Bluetooth, and/or Wi-Fi communications.

As explained above, contactless card 602 may be built on a software platform operable on smart cards or other devices having limited memory, such as JavaCard, and one or more applications or applets may be securely executed. Applet(s) 908 may be added to contactless cards to provide a one-time password (OTP) for multifactor authentication (MFA) in various mobile application-based use cases. Applet(s) 908 may be configured to respond to one or more requests, such as near field data exchange requests, from a reader, such as a mobile NFC reader (e.g., of a mobile device or point-of-sale terminal), and produce an NDEF message that comprises a cryptographically secure OTP encoded as an NDEF text tag.

One example of an NDEF OTP is an NDEF short-record layout (SR=1). In such an example, one or more applet(s) 908 may be configured to encode the OTP as an NDEF type 4 well known type text tag. In some implementations, NDEF messages may comprise one or more records. The applet(s) 908 may be configured to add one or more static tag records in addition to the OTP record.

In some implementations, the one or more applet(s) 908 may be configured to emulate an RFID tag. The RFID tag may include one or more polymorphic tags. In some implementations, each time the tag is read, different cryptographic data is presented that may indicate the authenticity of the contactless card. Based on the one or more applet(s) 908, an NFC read of the tag may be processed, the data may be transmitted to a server, such as a server of a banking system, and the data may be validated at the server.

In some implementations, the contactless card 602 and server may include certain data such that the card may be properly identified. The contactless card 602 may include one or more unique identifiers (not pictured). Each time a read operation takes place, the counter(s) 910 may be configured to increment. In some implementations, each time data from the contactless card 602 is read (e.g., by a mobile device), the counter(s) 910 is transmitted to the server for validation and determines whether the counter(s) 910 are equal (as part of the validation) to a counter of the server.

The one or more counter(s) 910 may be configured to prevent a replay attack. For example, if a cryptogram has been obtained and replayed, that cryptogram is immediately rejected if the counter(s) 910 has been read or used or otherwise passed over. If the counter(s) 910 has not been used, it may be replayed. In some implementations, the counter that is incremented on the card is different from the counter that is incremented for transactions. The contactless card 101 is unable to determine the application transaction counter(s) 910 since there is no communication between applet(s) 908 on the contactless card 602.

In some implementations, the counter(s) 910 may get out of sync. In some implementations, to account for accidental reads that initiate transactions, such as reading at an angle, the counter(s) 910 may increment but the application does not process the counter(s) 910. In some implementations, when the mobile device 10 is woken up, NFC may be enabled and the device 110 may be configured to read available tags, but no action is taken responsive to the reads.

To keep the counter(s) 910 in sync, an application, such as a background application, may be executed that would be configured to detect when the mobile device 110 wakes up and synchronize with the server of a banking system indicating that a read that occurred due to detection to then move the counter 104 forward. In other examples, Hashed One Time Password may be utilized such that a window of mis-synchronization may be accepted. For example, if within a threshold of 10, the counter(s) 910 may be configured to move forward. But if within a different threshold number, for example within 10 or 1000, a request for performing re-synchronization may be processed which requests via one or more applications that the user tap, gesture, or otherwise indicate one or more times via the user's device. If the counter(s) 910 increases in the appropriate sequence, then it is possible to know that the user has done so.

The key diversification technique described herein with reference to the counter(s) 910, master key, and diversified key, is one example of encryption and/or decryption a key diversification technique. This example key diversification technique should not be considered limiting of the disclosure, as the disclosure is equally applicable to other types of key diversification techniques.

During the creation process of the contactless card 602, two cryptographic keys may be assigned uniquely per card. The cryptographic keys may comprise symmetric keys which may be used in both encryption and decryption of data. Triple DES (3DES) algorithm may be used by EMV and it is implemented by hardware in the contactless card 602. By using the key diversification process, one or more keys may be derived from a master key based upon uniquely identifiable information for each entity that requires a key.

In some implementations, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 101 is used in operation, a different key may be used for creating the message authentication code (MAC) and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some implementations, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

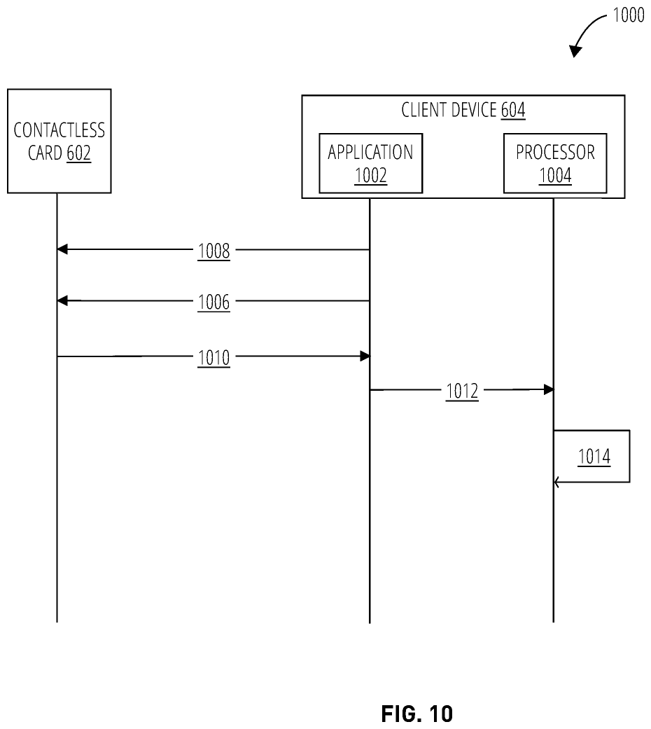

FIG. 10 is a timing diagram illustrating an example sequence for providing authenticated access, according to some implementations of the current subject matter. Sequence flow 1000 may include contactless card 602 and client device 604, which may include an application 1002 and processor 1004.

At line 1008, the application 1002 communicates with the contactless card 602 (e.g., after being brought near the contactless card 602). Communication between the application 1002 and the contactless card 602 may involve the contactless card 602 being sufficiently close to a card reader (not shown) of the client device 604 to enable NFC data transfer between the application 1002 and the contactless card 602.

At line 1006, after communication has been established between client device 604 and contactless card 602, contactless card 602 generates a message authentication code (MAC) cryptogram. In some implementations, this may occur when the contactless card 602 is read by the application 1002. In particular, this may occur upon a read, such as an NFC read, of a near field data exchange (NDEF) tag, which may be created in accordance with the NFC Data Exchange Format. For example, a reader application, such as application 1002, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 602 may be updated or incremented, which may be followed by “Read NDEF file.” At this point, the message may be generated which may include a header and a shared secret. Session keys may then be generated. The MAC cryptogram may be created from the message, which may include the header and the shared secret. The MAC cryptogram may then be concatenated with one or more blocks of random data, and the MAC cryptogram and a random number (RND) may be encrypted with the session key. Thereafter, the cryptogram and the header may be concatenated, and encoded as ASCII hex and returned in NDEF message format (responsive to the “Read NDEF file” message).

In some implementations, the MAC cryptogram may be transmitted as an NDEF tag, and in other examples the MAC cryptogram may be included with a uniform resource indicator (e.g., as a formatted string). In some implementations, application 1002 may be configured to transmit a request to contactless card 602, the request comprising an instruction to generate a MAC cryptogram.

At line 1010, the contactless card 602 sends the MAC cryptogram to the application 1002. In some implementations, the transmission of the MAC cryptogram occurs via NFC, however, the present disclosure is not limited thereto. In other examples, this communication may occur via Bluetooth, Wi-Fi, or other means of wireless data communication. At line 1012, the application 1002 communicates the MAC cryptogram to the processor 1004.

At line 1014, the processor 1004 verifies the MAC cryptogram pursuant to an instruction from the application 122. For example, the MAC cryptogram may be verified, as explained below. In some implementations, verifying the MAC cryptogram may be performed by a device other than client device 604, such as a server of a banking system in data communication with the client device 604. For example, processor 1004 may output the MAC cryptogram for transmission to the server of the banking system, which may verify the MAC cryptogram. In some implementations, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

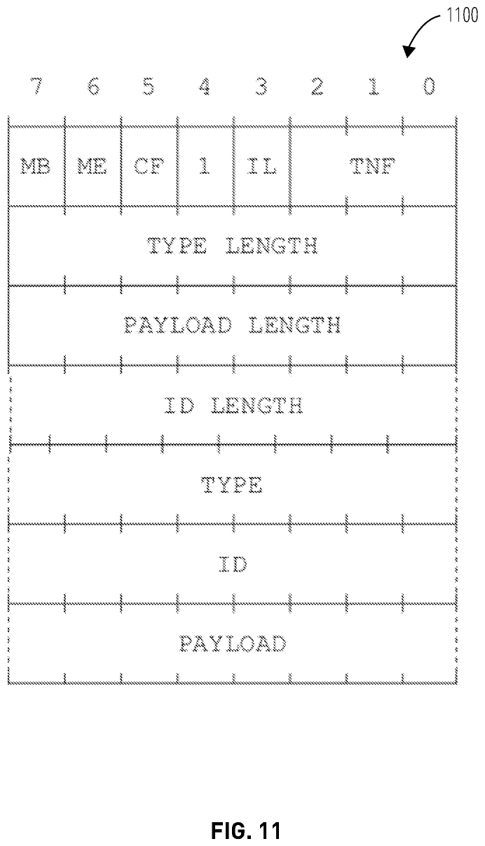

FIG. 11 illustrates an NDEF short-record layout (SR=1) data structure 1100, according to some implementations of the current subject matter. One or more applets may be configured to encode the OTP as an NDEF type 4 well known type text tag. In some implementations, NDEF messages may comprise one or more records. The applets may be configured to add one or more static tag records in addition to the OTP record. Exemplary tags include, without limitation, Tag type: well-known type, text, encoding English (en); Applet ID: D2760000850101; Capabilities: read-only access; Encoding: the authentication message may be encoded as ASCII hex; type-length-value (TLV) data may be provided as a personalization parameter that may be used to generate the NDEF message. In some implementations, the authentication template may comprise the first record, with a well-known index for providing the actual dynamic authentication data.

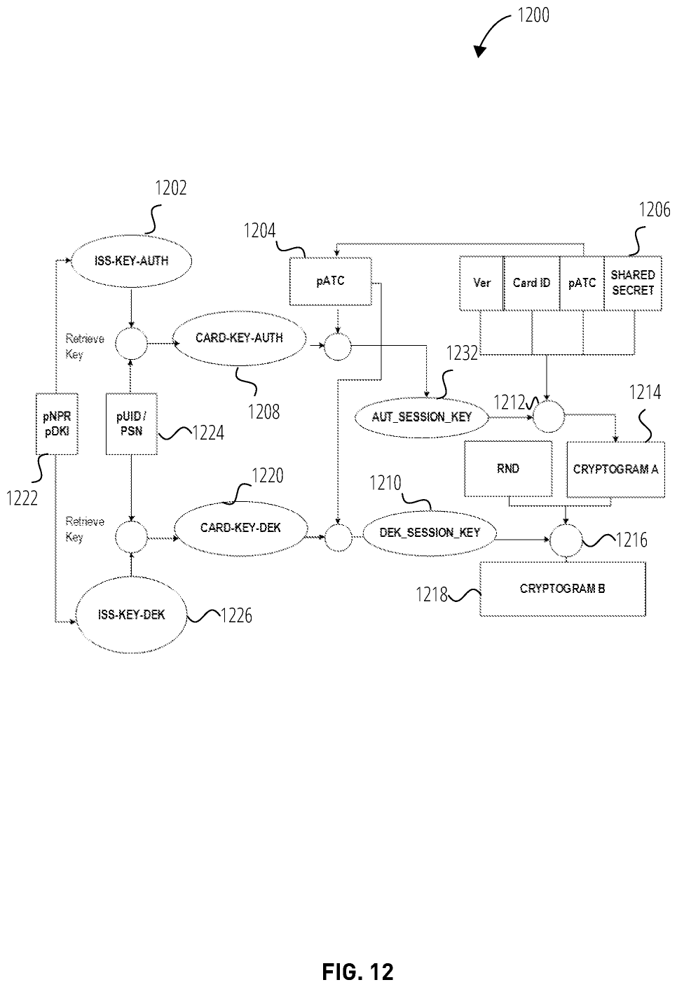

FIG. 12 illustrates a diagram of a system 1200, according to some implementations of the current subject matter. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1202, 1226 may be required for each part of the portfolio on which the one or more applets is issued. For example, the first master key 1202 may comprise an Issuer Cryptogram Generation/Authentication Key (Iss-Key-Auth) and the second master key 1226 may comprise an Issuer Data Encryption Key (Iss-Key-DEK). As further explained herein, two issuer master keys 1202, 1226 are diversified into card master keys 1208, 1220, which are unique for each card. In some implementations, a network profile record ID (pNPR) 522 and derivation key index (pDKI) 1224, as back office data, may be used to identify which Issuer Master Keys 1202, 1226 to use in the cryptographic processes for authentication. The system performing the authentication may be configured to retrieve values of pNPR 1222 and pDKI 1224 for a contactless card at the time of authentication.

In some implementations, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1208 and Card-Key-Dek 1220). The session keys (Aut-Session-Key 1232 and DEK-Session-Key 1210) may be generated by the one or more applets and derived by using the application transaction counter (pATC) 1204 with one or more algorithms. To fit data into the one or more algorithms, only the 2 low order bytes of the 4-byte pATC 1204 is used. In some implementations, the four byte session key derivation method may comprise: F1:=PATC(lower 2 bytes)∥‘F0’∥‘00’∥PATC (four bytes) F1:=PATC(lower 2 bytes)∥‘0F’∥‘00’∥PATC (four bytes) SK:={(ALG (MK) [F1])∥ALG (MK) [F2]}, where ALG may include 3DES ECB and MK may include the card's unique derived master key.

As described herein, one or more MAC session keys may be derived using the lower two bytes of pATC 1204 counter. At each tap of the contactless card, pATC 1204 is configured to be updated, and the card master keys Card-Key-AUTH 508 and Card-Key-DEK 1220 are further diversified into the session keys Aut-Session-Key 1232 and DEK-Session-KEY 1210. pATC 1204 may be initialized to zero at personalization or applet initialization time. In some implementations, the pATC counter 1204 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some implementations, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some implementations, only the authentication data and an 8-byte random number followed by MAC of the authentication data may be included. In some implementations, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1232. The data specified in cryptogram may be processed with javacard.signature method: ALG_DES MAC8_ISO9797_1_M2_ALG3 to correlate to EMV ARQC verification methods. The key used for this computation may comprise a session key AUT-Session-Key 1232, as explained above. As explained above, the low order two bytes of the counter may be used to diversify for the one or more MAC session keys. As explained below, AUT-Session-Key 1232 may be used to MAC data 1206, and the resulting data or cryptogram A 1214 and random number RND may be encrypted using DEK-Session-Key 1210 to create cryptogram B or output 1218 sent in the message.

In some implementations, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1210 derived from the Card-Key-DEK 1220. In this case, the ATC value for the session key derivation is the least significant byte of the counter pATC 1204.

The format below represents a binary version example embodiment. Further, In some implementations, the first byte may be set to ASCII ‘A’.

Message Format

| 1 | 2 | 4 | 8 | 8 |
|---|---|---|---|---|
| 0x43 (Message Type ‘A’) | Version | pATC | RND | Cryptogram A (MAC) |
| Cryptogram A (MAC) | 8 bytes | | | |

| Mac of | | | | |
|---|---|---|---|---|
| 2 | 8 | 4 | 4 | 18 bytes input data |
| Version | pUID | pATC | Shared Secret | |

Message Format

| 1 | 2 | 4 | | 16 | |
|---|---|---|---|---|---|
| 0x43 (Message Type ‘A’) | Version | pATC | | Cryptogram B | |
| Cryptogram A (MAC) | 8 bytes | | | | |
| MAC of | | | | | |
| 2 | 8 | 4 | 4 | | 18 bytes input data |
| Version | pUID | pATC | Shared Secret | | |
| Cryptogram B | 16 | | | | |
| Sym Encryption of | | | | | |
| 8 | 8 | | | | |

| | |
|---|---|
| RND | Cryptogram A |

Another exemplary format is shown below. In this example, the tag may be encoded in hexadecimal format.

Message Format

| 2 | 8 | 4 | 8 | 8 |
|---|---|---|---|---|
| Version | pUID | pATC | RND | Cryptogram A (MAC) |
| 8 bytes | | | | |

| 8 | 8 | 4 | 4 | 18 bytes input data |
|---|---|---|---|---|
| pUID | pUID | pATC | Shared Secret | |

Message Format

| 2 | 8 | 4 | | 16 | |
|---|---|---|---|---|---|
| Version | pUID | pATC | | Cryptogram B | |
| 8 bytes | | | | | |
| 8 | | 4 | 4 | | 18 bytes input data |
| pUID | pUID | pATC | Shared Secret | | |
| Cryptogram B | 16 | | | | |
| Sym Encryption of | | | | | |
| 8 | 8 | | | | |
| RND | Cryptogram A | | | | |

The UID field of the received message may be extracted to derive, from master keys Iss-Key-AUTH 502 and Iss-Key-DEK 1226, the card master keys (Card-Key-Auth 1208 and Card-Key-DEK 1220) for that particular card. Using the card master keys (Card-Key-Auth 508 and Card-Key-DEK 1220), the counter (pATC) field of the received message may be used to derive the session keys (Aut-Session-Key 1232 and DEK-Session-Key 1210) for that particular card. Cryptogram B 1218 may be decrypted using the DEK-Session-KEY, which yields cryptogram A 1214 and RND, and RND may be discarded. The UID field may be used to look up the shared secret of the contactless card which, along with the Ver, UID, and pATC fields of the message, may be processed through the cryptographic MAC using the re-created Aut-Session-Key to create a MAC output, such as MAC′. If MAC′ is the same as cryptogram A 1214, then this indicates that the message decryption and MAC checking have all passed. Then the pATC may be read to determine if it is valid.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1232. The input data 1206 may take the following form: Version (2), pUID (8), pATC (4), Shared Secret (4). In some implementations, the numbers in the brackets may comprise length in bytes. In some implementations, the shared secret may be generated by one or more random number generators which may be configured to ensure, through one or more secure processes, that the random number is unpredictable. In some implementations, the shared secret may comprise a random 4-byte binary number injected into the card at personalization time that is known by the authentication service. During an authentication session, the shared secret may not be provided from the one or more applets to the mobile application. Method 2 padding may include adding a mandatory 0x′80′ byte to the end of input data and 0x′00′ bytes that may be added to the end of the resulting data up to the 8-byte boundary. The resulting cryptogram may comprise 8 bytes in length.

In some implementations, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some implementations, the pATC may start at zero and be updated by 1 each time the one or more applications generates authentication data. The authentication service may be configured to track the pATCs used during authentication sessions. In some implementations, when the authentication data uses a pATC equal to or lower than the previous value received by the authentication service, this may be interpreted as an attempt to replay an old message, and the authenticated may be rejected. In some implementations, where the pATC is greater than the previous value received, this may be evaluated to determine if it is within an acceptable range or threshold, and if it exceeds or is outside the range or threshold, verification may be deemed to have failed or be unreliable. In the MAC operation 1212, data 1206 is processed through the MAC using Aut-Session-Key 1232 to produce MAC output (cryptogram A) 1214, which is encrypted.

In order to provide additional protection against brute force attacks exposing the keys on the card, it is desirable that the MAC cryptogram 1214 be enciphered. In some implementations, data or cryptogram A 1214 to be included in the ciphertext may comprise: Random number (8), cryptogram (8). In some implementations, the numbers in the brackets may comprise length in bytes. In some implementations, the random number may be generated by one or more random number generators which may be configured to ensure, through one or more secure processes, that the random number is unpredictable. The key used to encipher this data may comprise a session key. For example, the session key may comprise DEK-Session-Key 1210. In the encryption operation 1216, data or cryptogram A 1214 and RND are processed using DEK-Session-Key 510 to produce encrypted data, cryptogram B 1218. The data 1214 may be enciphered using 3DES in cipher block chaining mode to ensure that an attacker must run any attacks over all of the ciphertext. As a non-limiting example, other algorithms, such as Advanced Encryption Standard (AES), may be used. In some implementations, an initialization vector of 0x′0000000000000000′ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile device in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

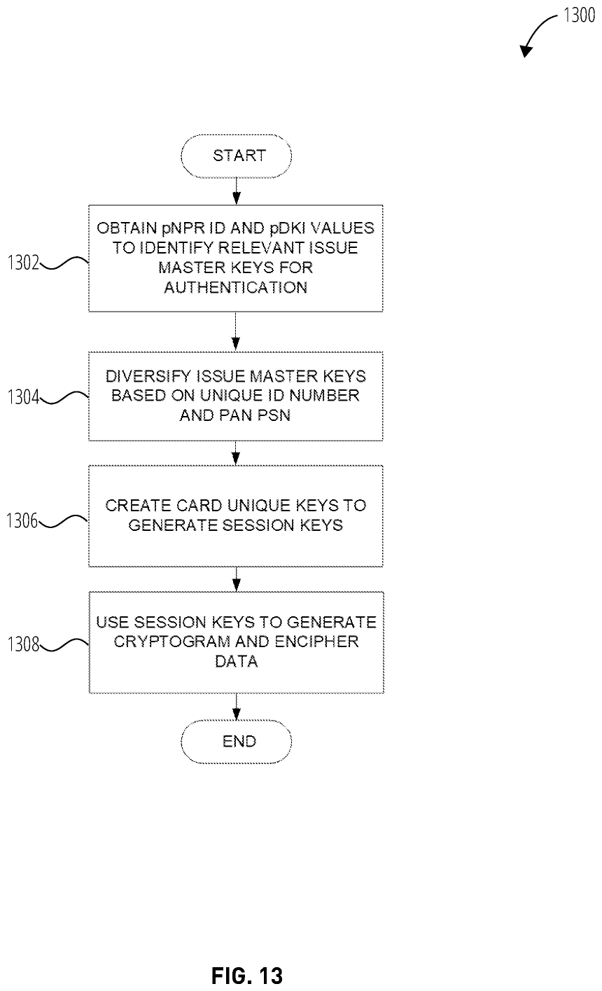

FIG. 13 illustrates a method 1300 for generating a cryptogram, according to some implementations of the current subject matter. For example, at block 1302, a network profile record ID (pNPR) and derivation key index (pDKI) may be used to identify which Issuer Master Keys to use in the cryptographic processes for authentication. In some implementations, the method may include performing the authentication to retrieve values of pNPR and pDKI for a contactless card at the time of authentication.

At 1304, Issuer Master Keys may be diversified by combining them with the card's unique ID number (pUID) and the PAN sequence number (PSN) of one or more applets, for example, a payment applet.

At 1306, Card-Key-Auth and Card-Key-DEK (unique card keys) may be created by diversifying the Issuer Master Keys to generate session keys which may be used to generate a MAC cryptogram.

At 1308, the keys used to generate the cryptogram and encipher the data in the one or more applets may comprise the session keys of block 1030 based on the card unique keys (Card-Key-Auth and Card-Key-DEK). In some implementations, these session keys may be generated by the one or more applets and derived by using pATC, resulting in session keys Aut-Session-Key and DEK-Session-Key.

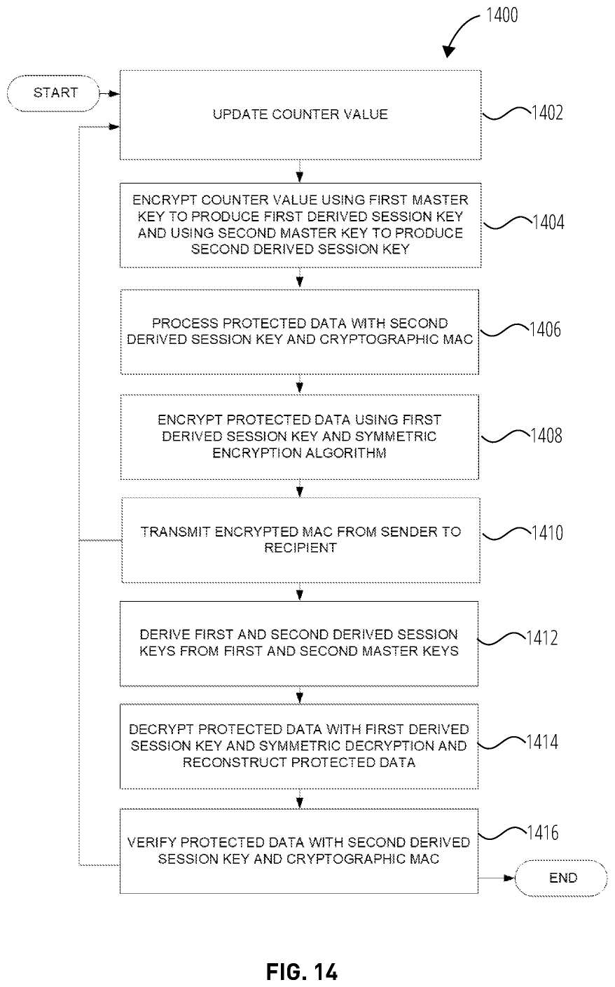

FIG. 14 depicts an exemplary process 1400 illustrating key diversification, according to some implementations of the current subject matter. Initially, a sender and the recipient may be provisioned with two different master keys. For example, a first master key may comprise the data encryption master key, and a second master key may comprise the data integrity master key. The sender has a counter value, which may be updated at block 1402, and other data, such as data to be protected, which it may secure share with the recipient.

At 1404, the counter value may be encrypted by the sender using the data encryption master key to produce the data encryption derived session key, and the counter value may also be encrypted by the sender using the data integrity master key to produce the data integrity derived session key. In some implementations, a whole counter value or a portion of the counter value may be used during both encryptions.

In some implementations, the counter value may not be encrypted. In these examples, the counter may be transmitted between the sender and the recipient in the clear, i.e., without encryption.

At 1406, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At 1408, the data to be protected may be encrypted by the sender using the data encryption derived session key in conjunction with a symmetric encryption algorithm. In some implementations, the MAC is combined with an equal amount of random data, for example each 8 bytes long, and then encrypted using the second session key (DEK-Session-Key).

At 1410, the encrypted MAC is transmitted, from the sender to the recipient, with sufficient information to identify additional secret information (such as shared secret, master keys, etc.), for verification of the cryptogram.

At 1412, the recipient uses the received counter value to independently derive the two derived session keys from the two master keys as explained above.

At 1414, the data encryption derived session key is used in conjunction with the symmetric decryption operation to decrypt the protected data. Additional processing on the exchanged data will then occur. In some implementations, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At 1416, the data integrity derived session key is used in conjunction with the cryptographic MAC operation to verify that the protected data has not been modified.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations.

Thereafter, the two derived session keys may be discarded, and the next iteration of data exchange will update the counter value (returning to block 1402) and a new set of session keys may be created (at block 1410). In some implementations, the combined random data may be discarded.

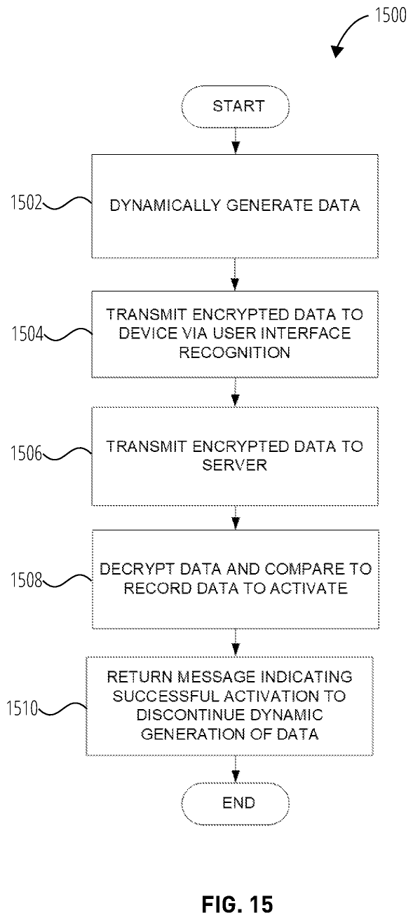

FIG. 15 illustrates a method 800 for card activation, according to some implementations of the current subject matter. For example, card activation may be completed by a system including a card, a device, and one or more servers. The contactless card, device, and one or more servers may reference the same or similar components that were previously explained above, such as contactless card 602, client device 604, and a server.

The card may be configured to dynamically generate data. In some implementations, this data may include information such as an account number, card identifier, card verification value, or phone number, which may be transmitted from the card to the device. In some implementations, one or more portions of the data may be encrypted via the systems and methods disclosed herein.

At 1504, one or more portions of the dynamically generated data may be communicated to an application of the device via NFC or other wireless communication. For example, a tap of the card proximate to the device may allow the application of the device to read the one or more portions of the data associated with the contactless card. In some implementations, if the device does not comprise an application to assist in activation of the card, the tap of the card may direct the device or prompt the customer to a software application store to download an associated application to activate the card. In some implementations, the user may be prompted to sufficiently gesture, place, or orient the card towards a surface of the device, such as either at an angle or flatly placed on, near, or proximate the surface of the device. Responsive to a sufficient gesture, placement and/or orientation of the card, the device may proceed to transmit the one or more encrypted portions of data received from the card to the one or more servers.

At 1506, the one or more portions of the data may be communicated to one or more servers, such as a card issuer server. For example, one or more encrypted portions of the data may be transmitted from the device to the card issuer server for activation of the card.

At 1508, the one or more servers may decrypt the one or more encrypted portions of the data via the systems and methods disclosed herein. For example, the one or more servers may receive the encrypted data from the device and may decrypt it in order to compare the received data to record data accessible to the one or more servers. If a resulting comparison of the one or more decrypted portions of the data by the one or more servers yields a successful match, the card may be activated. If the resulting comparison of the one or more decrypted portions of the data by the one or more servers yields an unsuccessful match, one or more processes may take place. For example, responsive to the determination of the unsuccessful match, the user may be prompted to tap, swipe, or wave gesture the card again. In this case, there may be a predetermined threshold comprising a number of attempts that the user is permitted to activate the card. Alternatively, the user may receive a notification, such as a message on his or her device indicative of the unsuccessful attempt of card verification and to call, email or text an associated service for assistance to activate the card, or another notification, such as a phone call on his or her device indicative of the unsuccessful attempt of card verification and to call, email or text an associated service for assistance to activate the card, or another notification, such as an email indicative of the unsuccessful attempt of card verification and to call, email or text an associated service for assistance to activate the card.

At 1510, the one or more servers may transmit a return message based on the successful activation of the card. For example, the device may be configured to receive output from the one or more servers indicative of a successful activation of the card by the one or more servers. The device may be configured to display a message indicating successful activation of the card. Once the card has been activated, the card may be configured to discontinue dynamically generating data so as to avoid fraudulent use. In this manner, the card may not be activated thereafter, and the one or more servers are notified that the card has already been activated.

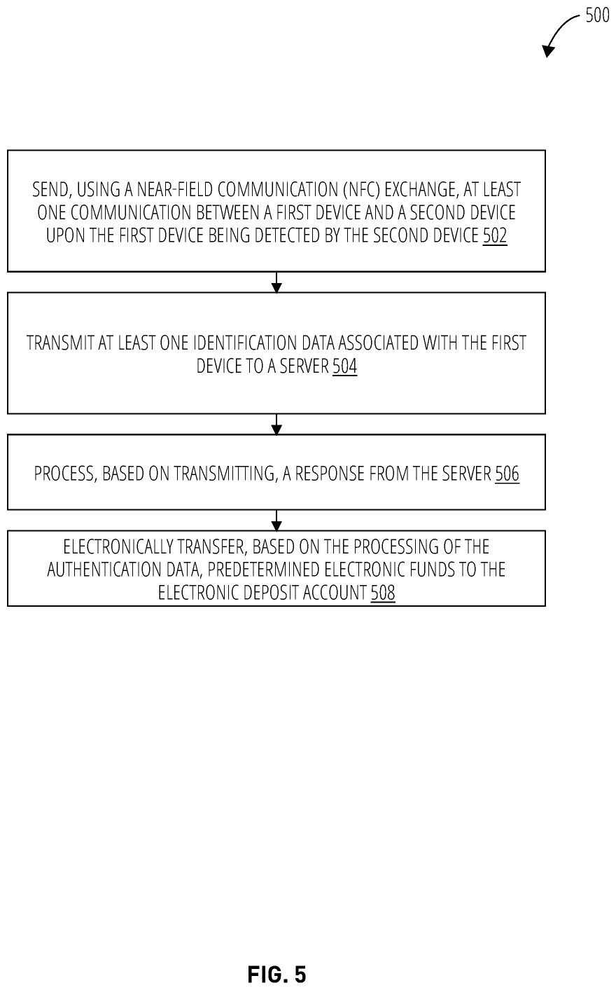

The various elements of the devices as previously described with reference to FIGS. 1-15 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores”, may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writable or rewritable media, digital or analog media, hard disk, floppy disk, Compact Disk Read Only Memory (CD-ROM), Compact Disk Recordable (CD-R), Compact Disk Rewritable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed:

1. A computer-implemented method, comprising:
executing a near-field communication (NFC) exchange between a first device and a second device upon the first device being detected by the second device to be located within a predetermined distance of the second device, the first device being associated with an electronic deposit account capable of receiving an electronic transfer of funds;
receiving at least one identification data associated with the first device, and sending the at least one identification data to a server, the at least one identification data being received from the first device based on the NFC exchange;
processing a response from the server, the response including an authentication data corresponding to the first device and associated with the sending the at least one identification data;
receiving a request for electronically transferring predetermined electronic funds to the electronic deposit account; and
electronically transferring, based on the processing of the authentication data, the predetermined electronic funds to the electronic deposit account.

2. The method according to claim 1, wherein the executing includes triggering execution of an application by the second device for performing the electronically transferring;
the execution of the application includes generating at least one user interface, wherein the at least one user interface includes one or more form fields configured to be automatically populated using a first device data received from the first device during the NFC exchange.

3. The method according to claim 2, wherein the first device is a contactless card and the second device is a mobile device, wherein the first device data includes a contactless card data.

4. The method according to claim 3, wherein the contactless card data includes at least one of the following: an account number associated with the contactless card, an expiration date associated with the contactless card, a card verification value (CVV) associated with the contactless card, a billing address associated with the contactless card, a name of a user associated with the contactless card, and any combination thereof.

5. The method according to claim 3, wherein the mobile device is an active computing device and the contactless card is a passive computing device, wherein, in response to the executing of the NFC exchange, the mobile device is configured to transmit the at least one message to cause the contactless card to become temporarily active and transmit at least one of: the at least one identification data and the contactless card data, to the mobile device.

6. The method according to claim 3, wherein the authentication data corresponding to the contactless card includes encrypted authentication data corresponding to the contactless card.

7. The method according to claim 6, wherein the processing of the response from the server includes
decrypting the encrypted authentication data corresponding to the contactless card;
upon determining, based on the decrypted authentication data, that the contactless card has been authenticated by the server, performing the electronically transferring; and
upon determining, based on the decrypted authentication data, that the contactless card has not been authenticated by the server, preventing the electronically transferring.

8. The method according to claim 3, wherein the contactless card includes at least one of the following: a credit card, a debit card, an electronic gift card, a pre-paid credit card, a pre-paid debit card, and any combination thereof.

9. The method according to claim 3, wherein the electronically transferring includes
transmitting the received request for electronically transferring the predetermined electronic funds to the server, the server communicating the received request to at least another electronic deposit account storing the predetermined electronic funds; and
electronically transferring, in response to the server communicating the received request, the predetermined electronic funds from the at least another electronic deposit to the electronic deposit account.

10. The method according to claim 9, wherein the at least another electronic deposit is associated with the mobile device.

11. The method according to claim 1, wherein the first device is a first mobile device and the second device is a second mobile device.

12. The method according to claim 11, wherein the executing of the NFC exchange includes a peer-to-peer communication between the first mobile device and the second mobile device.

13. The method according to claim 12, wherein
the electronic deposit account includes a first electronic deposit account associated with the first mobile device; and
a second electronic deposit account is associated with the second mobile device;
wherein the electronically transferring includes electronically transferring, using the peer-to-peer communication, the predetermined electronic funds from the second electronic deposit account to the first electronic deposit account.

14. A system, comprising:
at least one processor; and
at least one non-transitory storage media storing instructions, that when executed by the at least one processor, cause the at least one processor to perform operations including
receiving at least one identification data associated with a first device communicatively coupled to a second device using a near-field communication (NFC), and sending the received at least one identification data to a server, the at least one identification data being received from the first device based on an NFC exchange between the first device and the second device;
processing an authentication data, received from the server and responsive to the at least one identification data, corresponding to the first device;
receiving a request for electronically transferring predetermined electronic funds to an electronic deposit account associated with the first device; and
electronically transferring, based on the processing of the authentication data, in response to the received request, the predetermined electronic funds to the electronic deposit account.

15. The system according to claim 14, wherein the at least one identification data transmitted to the server is encrypted.

16. The system according to claim 14, wherein the first device is a contactless card and the second device is a mobile device, wherein the first device data includes a contactless card data.

17. The system according to claim 16, wherein the contactless card data includes at least one of the following: an account number associated with the contactless card, an expiration date associated with the contactless card, a card verification value (CVV) associated with the contactless card, a billing address associated with the contactless card, a name of a user associated with the contactless card, and any combination thereof.

18. The system according to claim 16, wherein the mobile device is an active computing device and the contactless card is a passive computing device, wherein the mobile device is configured to transmit the at least one message to cause the contactless card to become temporarily active and transmit at least one of: the at least one identification data and the contactless card data, to the mobile device.

19. The system according to claim 14, wherein the first device is a first mobile device and the second device is a second mobile device, wherein the communicative coupling of the first and second devices includes a peer-to-peer communication between the first mobile device and the second mobile device.

20. A computer program product comprising a non-transitory machine-readable medium storing instructions that, when executed by at least one programmable processor, cause the at least one programmable processor to perform operations comprising:
sending, using a near-field communication (NFC) exchange, at least one communication between a first device and a second device upon the first device being detected by the second device, the first device being associated with an electronic deposit account capable of receiving an electronic transfer of funds;
transmitting at least one identification data associated with the first device to a server, the at least one identification data being received from the first device in response to the at least one communication exchanged between the first device and the second device;
processing, based on the transmitting, a response from the server, the response including an authentication data corresponding to the first device; and
electronically transferring, based on the processing of the authentication data, predetermined electronic funds to the electronic deposit account.
